(19) United States
(12) Patent Application Publication
(10) Pub. No.: US 2015/0166059 A1
(43) Pub. Date: Jun. 18, 2015

(54) AUTONOMOUS VEHICLE DRIVING SUPPORT SYSTEM AND AUTONOMOUS DRIVING METHOD PERFORMED BY THE SAME

(71) Applicant: AUTOMOTIVE RESEARCH & TESTING CENTER, Changhua Hsien (TW)

(72) Inventor: Ming-Kuan KO, Changhua Hsien (TW)

(73) Assignee: AUTOMOTIVE RESEARCH & TESTING CENTER, Changhua Hsien (TW)

(21) Appl. No.: 14/132,249

(22) Filed: Dec. 18, 2013

(51) Int. Cl. B60W 30/09; B60T 7/12

(52) U.S. Cl. CPC B60W 30/09; B60T 7/12

(57) ABSTRACT

An autonomous vehicle driving support system is mounted on a vehicle, is electrically connected to an electronic control unit (ECU) of the vehicle, and has a dangerous driving state determination device and a driving assistance device. The dangerous driving state determination device detects a driving condition of the driver and a collision possibility of the vehicle. The driving assistance device provides suitable driving assistance functions to control the vehicle through the ECU. Given the driving condition of the driver and the collision possibility, corresponding driving assistance function is provided to control the vehicle. Accordingly, the cost arising from an expensive detection system required for enhanced driving assistances to drivers and passengers can be reduced.

### BACKGROUND OF THE INVENTION

1. Field of the Invention

The present invention relates to a vehicle driving support system and method therefor, and more particularly to an autonomous vehicle driving support system and an autonomous driving method performed by the autonomous vehicle driving support system.

2. Description of the Related Art

Over the recent years, the society has gradually migrated into a society with aging population. Owing to health issues, the threat to driving safety arising from aging drivers on the road is on the rise. After taking medicine or drinking alcohol, drowsy driving is also a serious threat to the motoring public. Hence, safety of drivers and passengers is treated as a major goal of vehicle development. Besides higher collision safety coefficient for vehicle body and internal protection apparatus (such as airbag) for reducing the chance of drivers and passengers being hurt upon collision, advanced driver assistance systems (ADAS) are developed to provide parking assistance, 360-degree vehicle surround view, night driving, blind spot detection, automatic driving, body tilt, tire pressure monitoring system (TPMS), pedestrian detection and the like, which ensure safer driving assistance to drivers and passengers.

Given the SARTRE (Safe Road Trains for The Environment) project as an example, if detecting all vehicles on the road equipped with GPS (Global Positioning System) having a same driving route, the SARTRE system sends signals to the receivers of the vehicles with the same driving route for all the vehicles with the same driving route to be arranged in a line and move forward with one of the vehicles designated by the SARTRE system as a leading vehicle followed by the rest of the vehicles. All the vehicles carry equipment for lane keeping and forward collision warning (FCW) so that all the vehicles can be maintained to drive on the lane with a safe distance between the vehicles. However, if there is no lane marking or sideline marking on the roadway, the lane-keeping and FCW functions cannot be fulfilled as the SARTRE system fails to recognize where the lane and sideline are.

Furthermore, the autonomous vehicles developed by Google carry 3D radar (Three-dimensional light detection and ranging (LiDAR)) to scan obstacles in the proximity of the vehicles so as to establish electronic terrain maps with obstacles, and the autonomous vehicles are also collaborated with GPS to ensure safety of the vehicles. However, the increasing cost of Google's autonomous vehicles arises from the installation of expensive 3D LiDAR and the electronic terrain maps.

In sum, although the ADAS mounted in a vehicle provides drivers and passengers with safer autonomous driving assistance, such system should carry complicated or expensive equipment and fails to be applied to all road environments.

### SUMMARY OF THE INVENTION

An objective of the present invention is to provide an autonomous vehicle driving support system and an autonomous driving method performed by the same without requiring complicated or expensive detection system.

To achieve the foregoing objective, the autonomous vehicle driving support system mounted in a vehicle has a dangerous driving state determination device and a driving assistance device.

The dangerous driving state determination device detects a distance and an orientation between the vehicle and an external obstacle, provides a predicted collision value according to the distance and the orientation between the vehicle the external obstacle, compares the predicted collision value with a reference value to determine a collision possibility of colliding with the external obstacle, and determines behavioral competence and a risk level of a driver of the vehicle according to a driving condition of the driver.

The driving assistance device is electrically connected to the dangerous driving state determination device and has a controller selecting a control function according to the collision possibility and the behavioral competence and the risk level of the driver to control the vehicle.

To achieve the foregoing objective, the autonomous driving method has a dangerous driving state determination step and a vehicle driving assistance step.

The dangerous driving state determination step detects a distance and an orientation between the vehicle and an adjacent obstacle to a vehicle to generate a predicted collision value, calculates a collision possibility according to the predicted collision value of the vehicle, and detects a driving condition of a driver in the vehicle to determine if the driving condition is normal.

The vehicle driving assistance step selects a control function to activate driving intervention of the vehicle when the predicted collision value is higher than a reference value or when the driving condition of the driver is abnormal.

When detecting the driving condition of the driver and the collision possibility of the vehicle, the foregoing autonomous vehicle driving support system provides suitable or corresponding driving assistance functions, such as risk alert, emergency stop, automatic avoidance of obstacle or risk report to external rescue center, and controls the vehicle in collaboration with the original driving assistance system of the vehicle if the driving condition of the driver is abnormal or the collision possibility is high. Accordingly, the cost increase arising from an expensive detection system required for enhanced driving assistances to drivers and passengers can be improved.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an autonomous vehicle driving support system in accordance with the present invention; and

FIG. 2 is a flow diagram of an autonomous driving method in accordance with the present invention.

### DETAILED DESCRIPTION OF THE INVENTION

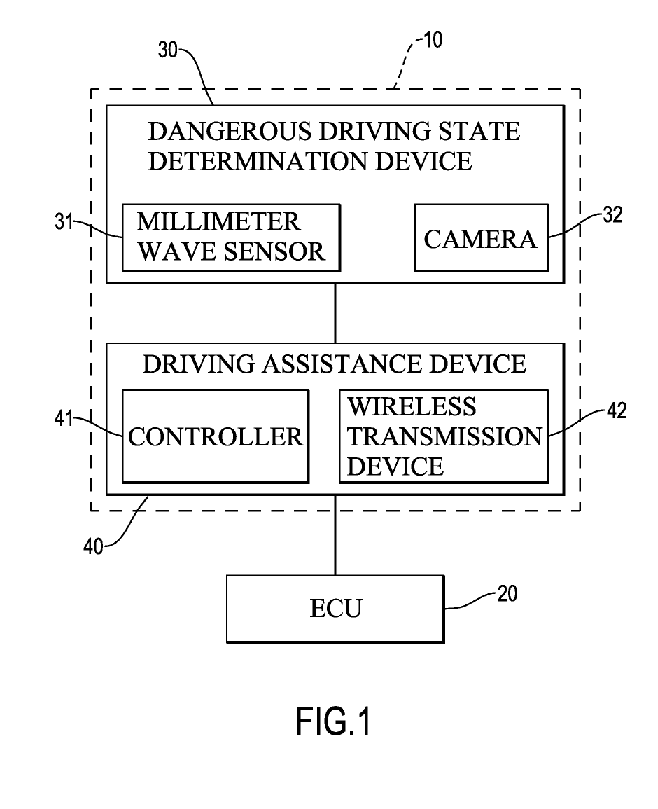

With reference to FIG. 1, an autonomous vehicle driving support system 10 in accordance with the present invention is mounted in a vehicle (hereafter present vehicle) is electrically connected to an electronic control unit (ECU) 20 for the autonomous vehicle driving support system 10 to control a travelling condition, such as acceleration/deceleration, turning angle of steering wheel, signal of direction indicators and the like, of the present vehicle through the ECU 20. The autonomous vehicle driving support system 10 has a dangerous driving state determination device 30 and a driving assistance device 40. The driving assistance device 40 is electrically connected to the dangerous driving state determination device 30 and the ECU 20.

The dangerous driving state determination device 30 serves to detect a distance and an orientation between the present vehicle and an external obstacle, such as lane fence, median island or pedestrian, or external vehicles and a driving condition of a driver of the present vehicle, and the dangerous driving state determination device 30 provides a predicted collision value according to the distance and the orientation between the present vehicle and the external obstacle (or an external vehicle). The predicted collision value is compared with a reference value to determine a collision possibility of colliding with the external obstacle or the external vehicle. The dangerous driving state determination device 30 determines behavioral competence and a risk level of the driver according to a driving condition of the driver.

In the present embodiment, the dangerous driving state determination device 30 has multiple detection units including a millimeter wave sensor 31 and a camera 32. The millimeter wave sensor 31 is mounted on a head of the present vehicle to detect the distance and the orientation between the present vehicle and the obstacle (or the external vehicle) in front of the present vehicle. It is possible for the multiple detection units to include multiple millimeter wave sensors or multiple cameras respectively mounted on a left side, a right side and a tail of the present vehicle, such as left and right sideview mirrors and rear bumper, to augment detection range over the two lateral sides and the tail of the present vehicle. The camera 32 serves to acquire an internal image of the present vehicle. The dangerous driving state determination device 30 determines the driving condition of the driver, such as drowsy, distracted or drunk driving, according to a recognition result of the internal image, classifies the behavioral competence and the risk level of the driver, and sends a signal corresponding to the behavioral competence and the risk level to the driving assistance device 40.

The driving assistance device 40 has a controller 41 that selects a corresponding control function to control the present vehicle through the ECU 20 according to the collision possibility calculated by the dangerous driving state determination device 30 and the classified behavioral competence and the risk level of the driver. The control function includes acceleration, deceleration, turning angle change of the steering wheel, signal switching of direction indicators and the like, to avoid possible collision with the external obstacle or the external vehicle. The driving assistance device 40 can also trigger visible and audible alerts on the dashboard of the present vehicle to warn the driver. The controller 41 is further connected to a wireless transmission device 42 to wirelessly transmit driving state information of the present vehicle or the driver in the form of wireless signal complying with any of the wireless technologies including 2G (Second Generation of mobile telecommunication technology), 3G (Third Generation of mobile telecommunication technology), WiFi (Wireless Fidelity) and LTE (Long Term Evolution) to an external rescue center. The driving state information includes the risk level or driving condition of the driver.

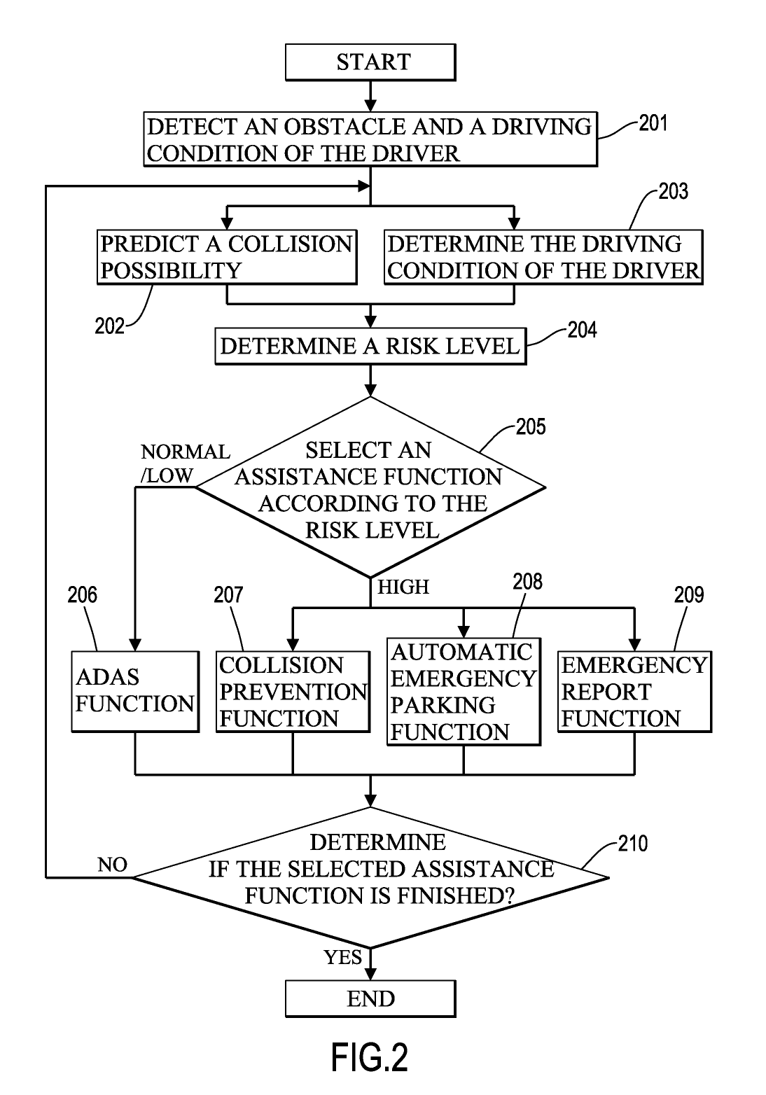

With reference to FIG. 2, an autonomous driving method in accordance with the present invention is performed by the foregoing autonomous vehicle driving support system and has the following steps.

Step 201: Detect an obstacle and a driving condition of the driver. The millimeter wave sensor 31 and the camera 32 of the dangerous driving state determination device 30 respectively detect a distance to the external obstacle, a speed and an orientation of the external obstacle, and the driving condition of the driver in the present vehicle.

Step 202: Estimate a collision possibility. Provide a predicated collision value according to the distance and the orientation between the present vehicle and the obstacle (or the external vehicle), and compare the predicted collision value with a reference value to determine the collision possibility between the present vehicle and the external vehicle.

Step 203: Determine the driving condition of the driver. Determine the driver's behavioral competence and the risk level according to a facial expression or a head posture, such as closed-eye expression or head-shaking posture, which is considered a drowsy condition of the driver pertaining to a high-risk level.

Step 204: Determine a risk level. Determine a risk level according to the collision possibility or the driver's behavioral competence. The determination of the risk level, the predicted collision value, the driving condition of the driver, and the options of assistance functions are listed in the following table.

| Risk | | Driving | |
|---|---|---|---|
| level | Predicted collision value | condition | Assistance function |
| Low | Low collision possibility | Normal | ADAS |
| | (<90%) | | |
| Medium | Low collision possibility | Distracted | ADAS |
| | (<90%) | | |
| High | Low collision possibility | Unconscious | Automatic emergency |
| | (<90%) | | parking functions and |
| | | | automatic report |
| | | | functions |
| | High collision possibility | Normal | Collision prevention |
| | (≧90%) | | assistance functions |
| | High collision possibility | Unconscious | Automatic emergency |
| | (≧90%) | | parking functions, |
| | | | collision prevention |
| | | | assistance functions |
| | | | and automatic report |
| | | | functions |

Step 205: Activate multiple assistance functions based on different levels of the risk level. The options of the assistance functions can be classified into the following four types depending on the collision possibility or the driver's behavioral competence.

Step 206: Perform an ADAS (Advanced Driver Assistance System) function. When the collision possibility is low (under 90%) and the driving condition of the driver is normal or when the collision possibility is low and the driving condition of driver is distracted, indicating that the corresponding risk level is determined to be low or medium, provide the drivers with the ADAS function for driver's alert upon a dangerous driving condition or assistance control upon an emergency. The ADAS function includes LDW (Lane Departure Warning), FCW (Forward Collision Warning), IODS (Image-Based Obstacle Detection), and the like.

Step 207: Perform a collision prevention assistance function when the collision possibility is high and the driving condition of the driver is normal, indicating that the corresponding risk level is determined to be high and there is a strong likelihood of vehicle collision. The controller 41 of the driving assistance device 40 then takes control of brake or accelerator of the present vehicle for the present vehicle to have an emergency stop or fast avoidance of the possible collision. The collision prevention assistance function controls the present vehicle to be within the lane through an LKS (Lane Keeping System), detects a vehicle ahead, and maintains a safe distance to the vehicle ahead through an ACC (Adaptive Cruise Control) system.

Step 208: Perform an automatic emergency parking function when the collision possibility is low and the driving condition of the driver is unconscious or when the collision possibility is high and the driving condition of the driver is unconscious, indicating that the corresponding risk level is determined to be high. The controller 41 performs an active control to detect obstacles or external vehicles around the present vehicle by using the millimeter wave sensor 31 mounted on the head of the present vehicle or the millimeter wave sensors 31 or the cameras 32 mounted on the two lateral sides or the tail of the present vehicle, so as to identify an obstacle-free driving (parking) path for the present vehicle to be parked beside a curb.

Step 209: Perform an emergency report function when the driving condition of the driver is unconscious. The controller 41 transmits a report message through the wireless transmission device 42 and a wireless network or a mobile network to a rescue center for emergency rescue or to an emergency contact person for emergency notification after the driver is found unconscious or a collision occurs.

Step 210: Determine if the selected assistance function is completed. If the present vehicle is still in the course of driving, continuously provide the selected assistance function. If the present vehicle is parked beside the curb or reaches a destination, terminate the assistance function.

From the foregoing, the autonomous vehicle driving support system detects the driving condition of the driver, calculates the collision possibility of the present vehicle, provides appropriate or corresponding driving assistance functions, and controls the present vehicle in collaboration with the ECU of the present vehicle when the driver's driving condition is not normal or the collision possibility is high. Accordingly, the present invention can resolve the increasing cost issue as a result of expensive detection equipment required for enhanced driving assistances to drivers and passengers.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An autonomous vehicle driving support system mounted in a vehicle, comprising:
a dangerous driving state determination device detecting a distance and an orientation between the vehicle and an external obstacle, providing a predicted collision value according to the distance and the orientation between the vehicle and the external obstacle, comparing the predicted collision value with a reference value to determine a collision possibility of colliding with the external obstacle, and determining behavioral competence and a risk level of a driver of the vehicle according to a driving condition of the driver; and
a driving assistance device electrically connected to the dangerous driving state determination device and having a controller selecting a control function according to the collision possibility and the behavioral competence and the risk level of the driver to control the vehicle.

2. The autonomous vehicle driving support system as claimed in claim 1, wherein the controller of the driving assistance device is adapted to electrically connect to an electronic control unit of the vehicle to accelerate and decelerate the vehicle, and change a turning angle of a steering wheel of the vehicle.

3. The autonomous vehicle driving support system as claimed in claim 2, wherein the controller provides alert or assistance control to the driver when the corresponding risk level is determined to be low, which is defined by a low collision possibility below 90% and a normal driving condition of the driver, or to be medium, which is defined by the low collision possibility and a distracted driving condition of the driver, and takes control of braking or acceleration of the vehicle for the vehicle to have an emergency stop or fast avoidance of a possible collision, or identifies an obstacle-free driving path for the vehicle to be parked beside a curb when the corresponding risk level is determined to be high, which is defined by corresponding one condition of the low collision possibility and an unconscious driving condition of the driver, a high collision possibility at and above 90% and the normal driving condition, and the high collision possibility and the unconscious driving condition.

4. The autonomous vehicle driving support system as claimed in claim 3, wherein the controller is further connected to a wireless transmission device to wirelessly transmit the risk level or the driving condition of the driver in the form of wireless signal.

5. The autonomous vehicle driving support system as claimed in claim 1, wherein the dangerous driving state determination device has multiple detection units to detect the distance and the orientation between the vehicle and the external obstacle and acquires an internal image of the vehicle to recognize the driving condition of the driver.

6. The autonomous vehicle driving support system as claimed in claim 2, wherein the dangerous driving state determination device has multiple detection units to detect the distance and the orientation between the vehicle and the external obstacle and acquires an internal image of the vehicle to recognize the driving condition of the driver.

7. The autonomous vehicle driving support system as claimed in claim 3, wherein the dangerous driving state determination device has multiple detection units to detect the distance and the orientation between the vehicle and the external obstacle and acquires an internal image of the vehicle to recognize the driving condition of the driver.

8. The autonomous vehicle driving support system as claimed in claim 4, wherein the dangerous driving state determination device has multiple detection units to detect the distance and the orientation between the vehicle and the external obstacle and acquires an internal image of the vehicle to recognize the driving condition of the driver.

9. The autonomous vehicle driving support system as claimed in claim 5, wherein the detection units include at least one millimeter wave sensor for detecting the distance and the orientation between the vehicle and the external obstacle and a camera for acquiring the internal image of the vehicle.

10. The autonomous vehicle driving support system as claimed in claim 6, wherein the detection units include at least one millimeter wave sensor for detecting the distance and the orientation between the vehicle and the external obstacle and a camera for acquiring the internal image of the vehicle.

11. The autonomous vehicle driving support system as claimed in claim 7, wherein the detection units include at least one millimeter wave sensor for detecting the distance and the orientation between the vehicle and the external obstacle and a camera for acquiring the internal image of the vehicle.

12. The autonomous vehicle driving support system as claimed in claim 8, wherein the detection units include at least one millimeter wave sensor for detecting the distance and the orientation between the vehicle and the external obstacle and a camera for acquiring the internal image of the vehicle.

13. An autonomous driving method, comprising:
a dangerous driving state determination step detecting a distance and an orientation between the vehicle and an adjacent obstacle to a vehicle to generate a predicted collision value, calculating a collision possibility according to the predicted collision value of the vehicle, and detecting a driving condition of a driver in the vehicle to determine if the driving condition is normal; and
a vehicle driving assistance step selecting a control function to activate driving intervention of the vehicle when the predicted collision value is higher than a reference value or when the driving condition of the driver is abnormal.

14. The autonomous driving method as claimed in claim 13, wherein in the dangerous driving state determination step, the predicted collision value is compared with a reference value to determine the collision possibility between the vehicle and another vehicle, and the driving condition of the driver is used to determine behavioral competence and a risk level of the driver.

15. The autonomous driving method as claimed in claim 14, wherein when the collision possibility pertains to a medium-risk level defined by a low collision possibility below 90% and a distracted driving condition of the driver or a low-risk level defined by the low collision possibility and a normal driving condition of the driver, in the vehicle driving assistance step, an advanced driver assistance system (ADAS) function is activated to control the vehicle, and the ADAS function provides alert or assistance control to the driver.

16. The autonomous driving method as claimed in claim 14, wherein when the collision possibility pertains to a high-risk level defined by one of the low collision possibility and an unconscious driving condition of the driver, a high collision possibility at and above 90% and the normal driving condition, and the high collision possibility and the unconscious driving condition in the vehicle driving assistance step, a collision prevention assistance function or an automatic emergency parking function is activated to control the vehicle, the collision prevention assistance function takes control of brake or accelerator of the vehicle, and the automatic emergency parking function identifies an obstacle-free driving path for the vehicle to be parked beside a curb.

17. The autonomous driving method as claimed in claim 14, wherein the vehicle driving assistance step further comprises the step of generating an emergency notification upon an emergency event when the driving condition of the driver is unconscious.
